(19) United States
(12) Patent Application Publication
(10) Pub. No.: US 2005/0258711 A1
(43) Pub. Date: Nov. 24, 2005

(54) Ultrasonic vibrator and ultrasonic motor including ultrasonic vibrator

(75) Inventor: Tomoki Funakubo, Tokyo (JP)

Correspondence Address: Thomas Spinelli;Scully, Scott, Murphy & Presser, 400 Garden City Plaza, Garden City, NY, 11530, US

(73) Assignee: Olympus Corporation, Tokyo (JP)

(21) Appl. No.: 11/124,715

(22) Filed: May 9, 2005

(30) Foreign Application Priority Data
May 20, 2004 (JP) 2004-150965

(51) Int. Cl. H02N 2/00

(52) U.S. Cl. 310/323.16

(57) ABSTRACT

An ultrasonic vibrator includes a piezoelectric laminated-section; a frictional contact-section serving as a driving point upon coming into contact with a moving-table serving as a driven body; and a pin serving as a projection and disposed at a node of a generated vibration. When alternating voltages are applied on external electrodes of the piezoelectric laminated-section, an ultrasonic elliptical vibration is generated at the frictional contact-section. The pin is composed of a resin member such as polyether-ether-ketone.

This Application claim benefit of Japanese Patent Application No. 2004-150965 filed in Japan on May 20, 2004, the contents of which are incorporated by this reference

### BACKGROUND OF THE INVENTION

1. Field of the Invention

The present invention relates to an ultrasonic vibrator and an ultrasonic motor including the ultrasonic vibrator.

2. Related Art Statement

A variety of ultrasonic motors are known, and an example is disclosed in Japanese Examined Patent Application Publication No. 3311446 (Japanese Unexamined Patent Application Publication No. 7-163162). A typical ultrasonic motor will be described, taking the ultrasonic motor disclosed in Japanese Examined Patent Application Publication No. 3311446 by way of example.

The ultrasonic motor generally includes an ultrasonic vibrator having a structure in which pluralities of thin rectangular first and second piezoelectric plates are alternately laminated, each piezoelectric plate having a pair of internal electrodes printed thereon.

The internal electrodes extend to the side surfaces or the upper surface of the ultrasonic vibrator. After the internal electrodes are printed on a green sheet composed of lead zirconate titanate (hereinafter, simply referred to as PZT), these piezoelectric plates are positioned and laminated on the green sheet, and then baked for forming a piezoelectric laminated-section.

External electrodes are disposed at positions of the piezoelectric laminated-section (two on the upper surface of the ultrasonic vibrator so as to serve as positive ones and two on the side surfaces of the same so as to serve as negative ones) where the internal electrodes of the ultrasonic vibrator are exposed.

In the piezoelectric laminated-section, electrical terminals are formed such that the external electrodes respectively disposed on the left of the upper surface and on the left side surface are connected to each other with respective lead wires. These electrical terminals are used for an A-phase, and alternating voltages are applied on these terminals, as will be described later.

Also, in the piezoelectric laminated-section, electrical terminals are formed such that the external electrodes respectively disposed on the right of the upper surface and on the right side surface are connected to each other with respective lead wires. These electrical terminals are used for a B-phase, and alternating voltages are applied on these terminals, as will be described later.

The electrical terminals for the A- and B-phases are subjected to a polarization process by applying respectively predetermined direct-current voltages thereon.

Also, in the piezoelectric laminated-section, a driving element (a frictional projection) is bonded to a position on the lower surface of the ultrasonic vibrator, where a bending vibration has substantially the maximum value of amplitude.

In the ultrasonic vibrator having the above-described structure, when alternating voltages being mutually π/2 out of phase are applied on the respective electrical terminals of the A- and B-phases, a primary longitudinal vibration and a secondary bending vibration are excited at the driving element, so that a large clockwise or counterclockwise elliptical vibration is produced.

In order to achieve an ultrasonic motor including the ultrasonic vibrator, the ultrasonic motor needs to further include a through-hole perforated at the central part of the ultrasonic vibrator; a pin for exerting a pressing force, inserted into and bonded to the through-hole; pressing means engaging with the pin and pressing the driving element in a predetermined direction; and a driven body coming into contact with the driving element of the ultrasonic vibrator and relatively moving with respect to the driving element.

The driven body is held by linear guides so as to be slidable while coming into contact with the driving element and being guided by the linear guides.

In the ultrasonic motor having the above-described structure, when alternating voltages mutually being π/2 out of phase are applied on the corresponding electrical terminals of the A- and B-phases of the ultrasonic vibrator, as described above, a primary longitudinal vibration and a secondary bending vibration are excited at the driving element, so that a large clockwise or counterclockwise elliptical vibration is produced, thereby causing the driven body to move horizontally.

### SUMMARY OF THE INVENTION

According to one aspect of the present invention, an ultrasonic vibrator includes a piezoelectric section; a frictional contact-section serving as a driving point upon coming into contact with a driven body and generating an ultrasonic elliptical vibration upon application of alternating voltages on the piezoelectric section; and a projection disposed at a node of a vibration generated in the piezoelectric section and composed of a resin member.

According to another aspect of the present invention, an ultrasonic vibrator includes a piezoelectric section; a frictional contact-section serving as a driving point upon coming into contact with a driven body and generating an ultrasonic elliptical vibration upon application of alternating voltages on the piezoelectric section; and a holding member holding the piezoelectric section.

According to another aspect of the present invention, an ultrasonic motor including the ultrasonic vibrator according to the present invention comprises: an ultrasonic vibrator including a piezoelectric section, a frictional contact-section serving as a driving point upon coming into contact with a driven body and generating an ultrasonic elliptical vibration upon application of alternating voltages on the piezoelectric section, and a projection disposed at a node of a vibration generated in the piezoelectric section; a projection-holding member holding the ultrasonic vibrator upon engagement with the projection; the driven body; and a pressing member generating a pressing force between the frictional contact-section and the driven body through the projection-holding member. The driven body moves relative to the frictional contact-section of the ultrasonic vibrator upon coming into contact with the same. At least either one of the projection and the projection-holding member is composed of a resin member.

According to the other aspect of the present invention, an ultrasonic motor having the ultrasonic vibrator according to the present invention comprises: an ultrasonic vibrator including a piezoelectric section, a frictional contact-section serving as a driving point upon coming into contact with a driven body and generating an ultrasonic elliptical vibration upon application of alternating voltages on the piezoelectric section, and a holding member holding the piezoelectric section, a holding-casing in which the holding member of the ultrasonic vibrator is inserted; the driven body; and a pressing member generating a pressing force between the frictional contact-section and the driven body through the holding-casing. The driven body moves relative to the frictional contact-section of the ultrasonic vibrator upon coming into contact with the same.

Additional features and advantages of the invention will be forth in the description which follows, and in part will be obvious from the description or may be leaned by practice of invention. The features and advantages of the invention may be realized and obtained by means of the instrumentalities and combinations particularly pointed out hereinafter.

### BRIEF DESCRIPTION OF THE DRAWINGS

FIG. 1 is a perspective view of the structure of an ultrasonic vibrator according to a first embodiment of the present invention;

FIG. 2 is an exploded perspective view of a major part of a piezoelectric laminated-section of the ultrasonic vibrator shown in FIG. 1;

FIG. 3A is a perspective view of the ultrasonic vibrator according to the present embodiment, having a state of a resonant longitudinal vibration;

FIG. 3B is a perspective view of the ultrasonic vibrator according to the present embodiment, having a state of a resonant bending vibration;

FIG. 4 is a sectional view of the internal structure of an ultrasonic motor including the ultrasonic vibrator according to the first embodiment;

FIG. 5 is a side view of a major part of the ultrasonic motor shown in FIG. 4;

FIG. 6 is a sectional view of a modification of a projection-holding member of the ultrasonic motor;

FIG. 7 is a perspective view of the structure of an ultrasonic vibrator according to a second embodiment of the present invention;

FIG. 8 is a sectional view of the ultrasonic vibrator shown in FIG. 7;

FIG. 9 is a sectional view of the ultrasonic vibrator shown in FIG. 7, having a holding-casing disposed therein;

FIG. 10 is a perspective view of a first modification of the ultrasonic vibrator according to the second embodiment;

FIG. 11 is a perspective view of a second modification of the ultrasonic vibrator according to the second embodiment;

FIG. 12 is a perspective view of a third modification of the ultrasonic vibrator according to the second embodiment;

FIG. 13 is a sectional view of the internal structure of an ultrasonic motor including the ultrasonic vibrator according to the second embodiment; and

FIG. 14 is a side view of a major part of the ultrasonic motor shown in FIG. 13.

### DETAILED DESCRIPTION OF THE PREFERRED EMBODIMENTS

Embodiments of the present invention will be described with reference to the attached drawings.

### First Embodiment

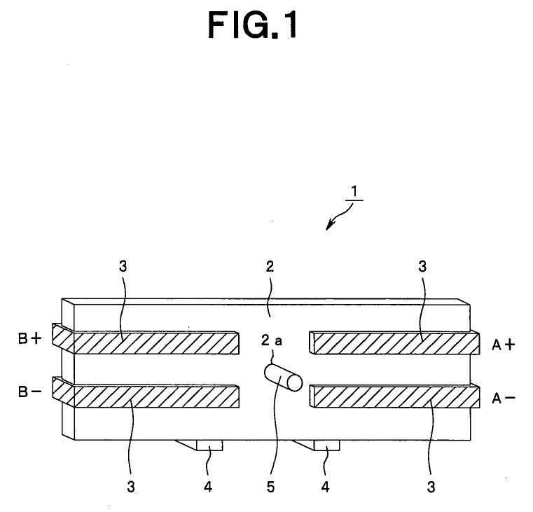

FIG. 1 is a perspective view of the structure of an ultrasonic vibrator according to a first embodiment of the present invention.

As shown in FIG. 1, an ultrasonic vibrator 1 according to the present embodiment is made up of piezoelectric elements and includes a piezoelectric laminated-section 2 formed in a substantially prismatic shape; external electrodes 3 disposed in a belt-shaped pattern, at four positions on the right and left side surfaces of the laminate-section 2 and at four positions on the front surface of the same; frictional contact-sections 4 disposed at two positions on the bottom surface of the same; and a pin 5 serving as a projection inserted in and bonded to a hole 2a bored substantially at the central part of the piezoelectric laminated-section 2.

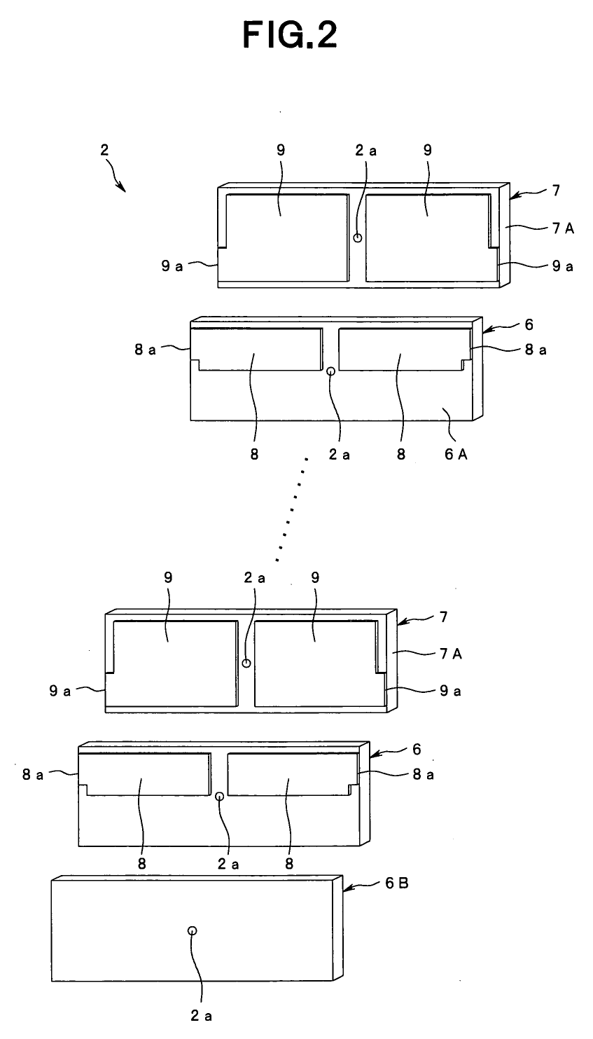

The piezoelectric laminated-section 2 has a structure, which will be described later in detail, in which pluralities of thin rectangular first and second piezoelectric sheets 6 and 7 (see FIG. 2) serving as piezoelectric ceramic sheets and undergoing an internal-electrode process are alternately laminated.

As will be described later, the external electrodes 3 lying on the side surface of the piezoelectric laminated-section 2 and shown on the right in FIG. 1 are fixed by baking silver, respectively to internal-electrode exposed-sections 8a and 9a (see FIG. 2) lying on the side surface of the piezoelectric laminated-section 2 and shown on the right in the same figure, whereby two electrical terminals (A+ and A−) form A (an A-phase). Also, as will be also described later, the external electrodes 3 lying on the side surface of the piezoelectric laminated-section 2 and shown on the left in FIG. 1 are respectively fixed by silver baking, respectively to other internal-electrode exposed-sections 8a and 9a (see FIG. 2) lying on the side surface of the piezoelectric laminated-section 2 and shown on the left in the same figure, whereby two electrical terminals (B+ and B−) form B (a B-phase).

The external electrodes 3 lying on the front surface shown in FIG. 1 are formed in a belt-shape, extending so as to be respectively connected to the two electrical terminals (A+ and A−) of the A-phase and the two electrical terminals (B+ and B−) of the B-phase. These extending external electrodes 3 are also formed by silver baking in the same fashion as described above.

The structure of the piezoelectric laminated-section 2 will be described in further detail with reference to FIG. 2.

FIG. 2 is an exploded perspective view of a major part of the piezoelectric laminated-section 2. As shown in FIG. 2, the piezoelectric laminated-section 2 has a structure in which the pluralities of the first piezoelectric sheets 6, each having a first internal electrode 8, and the second piezoelectric sheets 7, each having a second internal electrode 9, are alternately laminated.

Each of the first piezoelectric sheets 6 includes a piezoelectric layer 6A serving as a piezoelectric element and having the first internal electrode 8 printed thereon as will be described later.

Each of the second piezoelectric sheets 7 includes a piezoelectric layer 7A serving as a piezoelectric element, and having the second internal electrodes 9 printed thereon as will be described later.

Each of the first and second piezoelectric sheets 6 and 7 has an example thickness of 80 μm and is composed of a PZT (lead zirconate titanate) material in the present embodiment. The PZT material is hard with a large coefficient of mechanical quality (Q-value). In the present embodiment, the coefficient of mechanical quality (Q-value) is, for example 2500.

As shown in FIG. 2, the piezoelectric laminated-section 2 has a piezoelectric sheet 6B, composed of the same PZT material as that constituting the first and second piezoelectric sheets 6 and 7 and having no internal electrode printed thereon, laminated so as to serve as the first layer (the uppermost layer, corresponding to the first sheet of the first piezoelectric sheets 6 lying on the near side in the figure) of the plurality of the alternately laminated first and second piezoelectric sheets 6 and 7.

The first and second internal electrodes 8 and 9 are composed of a silver-palladium alloy (Ag—Pd) or silver (Ag).

In the ultrasonic vibrator 1 according to the present embodiment, the first and second internal electrodes 8 and 9 are alternately laminated in accordance with alternating lamination of the first and second piezoelectric sheets 6 and 7. In other words, in the piezoelectric laminated-section 2 according to the present embodiment, the piezoelectric sheet 6B, the first internal electrode 8, the piezoelectric layer 6A, the second internal electrode 9, the piezoelectric layer 7A, the piezoelectric layer 7A, . . . , the piezoelectric layer 7A, the first internal electrode 8, the piezoelectric layer 6A, the second internal electrode 9, and the piezoelectric layer 7A are laminated in that order.

The shapes of the internal electrodes of the first and second piezoelectric sheets 6 and 7 will be described.

The first internal electrode 8 disposed on the first piezoelectric sheets 6 has an example thickness of 5 to 10 μm. As shown in FIG. 2 in detail, with respect to the cross-sectional shape of the piezoelectric laminated-section 2, the first internal electrode 8 is arranged on the upper part of the entire area of one surface of the piezoelectric layer 6A and is divided into two right and left portions. A part of the first internal electrode 8 extends to the base ends on both side surfaces of the piezoelectric layer 6A so as to provide the respective internal-electrode exposed-sections 8a.

The second internal electrode 9 disposed on the second piezoelectric sheet 7 has an example thickness of 5 to 10 μm. With respect to the cross-sectional shape of the piezoelectric laminated-section 2, as shown in FIG. 2 in detail, the second internal electrode 9 is arranged on substantially the entire area of the piezoelectric layer 7A and is also divided into two right and left portions. Also, a part of the second internal electrode 9 extends to the base ends on both side surfaces of the piezoelectric layer 7A so as to provide the respective internal-electrode. exposed-sections 9a.

Each of the first and second piezoelectric sheets 6 and 7 has the hole 2a with an example diameter of 0.3 mm, perforated so as to pass through substantially the central part thereof. While the hole 2a is formed so as to pass through the corresponding piezoelectric sheet in the present embodiment, it is not always limited to a through-hole, and a hole having a predetermined dimension may be formed in the piezoelectric laminated-section 2. In this case, the pin 5 is bonded to a portion of piezoelectric laminated-section 2 corresponding to the hole 2a.

As shown in FIG. 1, the ultrasonic vibrator 1 including the piezoelectric laminated-section 2 having the above-described structure is formed such that the external electrodes 3 formed of silver-baking are respectively disposed at the corresponding internal-electrode exposed-sections 8a and 9a formed by arranging respective parts of the first and second internal electrodes 8 and 9 of the piezoelectric laminated-section 2 so as to extend to the base ends on both side surfaces of the ultrasonic vibrator 1.

In other words, as shown in FIG. 1, the external electrodes 3 lying on the side surfaces of the piezoelectric laminated-section 2 are disposed in a belt-shaped pattern so as to establish electrical connection with the corresponding internal-electrode exposed-sections 8a and 9a (see FIG. 2). Also, these external electrodes 3 are in electrical conduction with the other external electrodes 3 formed in a belt-shaped pattern and disposed on the front surface of the piezoelectric laminated-section 2 through edge portions of the piezoelectric laminated-section 2. External electrodes lying on the opposite side surface of the piezoelectric laminated-section 2 are likewise disposed.

Each of these external electrodes 3 has a lead wire (not shown) connected thereto, for example, by soldering, or a flexible substrate including electrodes, electrically bonded thereto and receives a drive signal from a drive circuit (not shown) through the lead wire or the flexible substrate.

The ultrasonic vibrator 1 according to the present embodiment has the frictional contact-sections 4 disposed at the positions on the bottom surface of the piezoelectric laminated-section 2, substantially corresponding to antinodes of a resonant bending-vibration. Each of the frictional contact-sections 4 is composed of a grinding-stone material, and, after cut into a square shape, is bonded to a predetermined position of the piezoelectric laminated-section 2.

The ultrasonic vibrator 1 also has the pin 5, serving as a projection and composed of a cylindrical resin material, inserted into and bonded to the hole 2a bored substantially at the central part thereof.

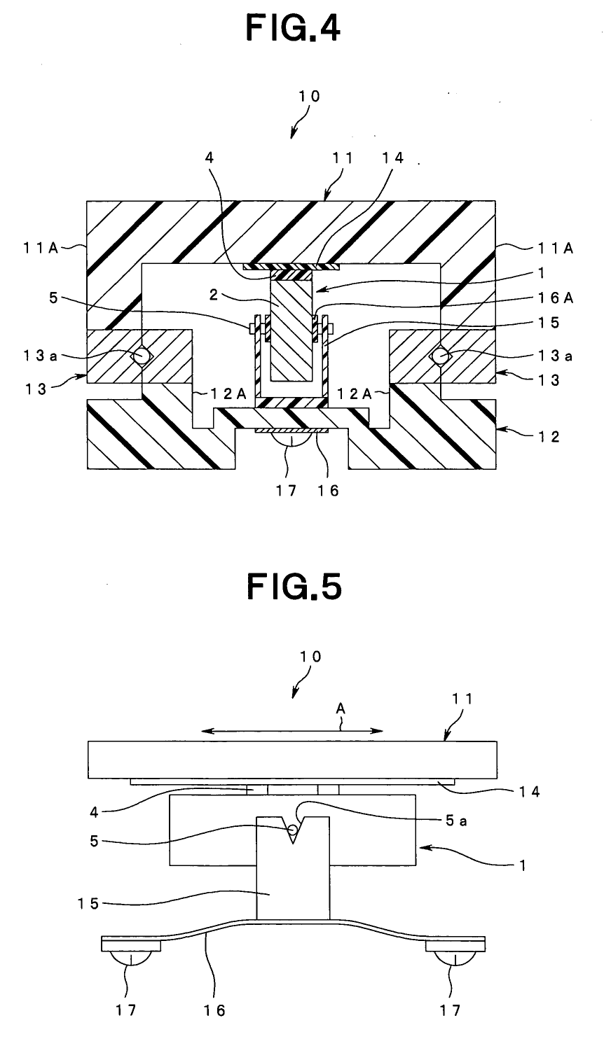

In the present embodiment, the pin 5 is composed of a highly functional resin such as polyether-ether-ketone (PEEK material: PEER R-polymer). That is, as will be described later, because of being strongly pressed by a projection-holding member 15 (see FIG. 4), the pin 5 is preferably composed of material such as the foregoing PEEK material having a high stiffness.

Other than the above-mentioned resin material, the pin 5 may be composed of a resin material such as nylon, polyethylene, polyacetal, ABS resin, polycarbonate, polysulfone, polyimide, polystyrene, polyphenylene sulfide, polypropylene, phenol resin, epoxy resin, or FRP resin.

Referring now to FIGS. 1 and 2, a method for fabricating the ultrasonic vibrator according to the present embodiment will be described.

According to the method for fabricating the ultrasonic vibrator according to the present embodiment, slurry is prepared by mixing temporally sintered PZT power and binder with each other, and is casted by a doctor blade method into film-shaped green sheets (corresponding to the piezoelectric layer 6A and 7A), each having a predetermined thickness. After dried, the green sheet is separated from the other film-shaped ones, thus resulting in a plurality of green sheets formed as described above.

Then, by printing an electrode material on a first green sheet by using a mask having a pattern of the first internal electrode 8 (see FIG. 2), the first piezoelectric sheet 6 shown in FIG. 2 is formed. In this case, the first internal electrode 8 is composed of a silver-palladium alloy (Ag—Pd).

Also, by printing an electrode material on a second green sheet by using a mask having a pattern of the second internal electrode 9 (see FIG. 2), the second piezoelectric sheet 7 shown in FIG. 2 is formed. Also, in this case, the second internal electrode 9 is composed of a silver-palladium alloy (Ag—Pd).

The first and second piezoelectric sheets 6 and 7 are then accurately positioned such that the first and second internal electrodes 8 and 9 overlap exactly with each other, and pluralities of these sheets are alternately laminated. Then, a third green sheet (not shown) having no internal electrode printed thereon is laminated so as to serve as the upper most layer of the laminate.

Then, the laminate including the first and second piezoelectric sheets 6 and 7, in addition to the third green sheet, is pressed so as to make the adjacent green sheets closely contact with each other and undergoes thermal-compression bonding. By baking the laminate having undergone the thermal-compression bonding at about 1200° C. and then by cutting it into a predetermined shape, a piezoelectric element corresponding to the piezoelectric laminated-section 2 is produced.

Each of the internal-electrode exposed-sections 8a and 9a (see FIG. 2) has the corresponding external electrode 3 having a belt-shape as shown in FIG. 1, formed thereat by silver-baking. Also, the external electrodes 3, each having a belt-shape each as shown in FIG. 1, are likewise formed on the surface of the piezoelectric laminated-section 2 by silver-baking. Then, by applying a high direct-current voltage on the A-phase (between A+ and A−) and the B-phase (between B+ and B−) of these external electrodes 3, each having a belt-shape as shown in FIG. 1, these external electrodes 3 are polarized and exhibit a piezoelectric feature.

Then, as shown in FIG. 2, the holes 2a are perforated at the central parts of the respective piezoelectric elements corresponding to the piezoelectric laminated-sections 2 of the laminates, by a processing machine such as a drill. The holes 2a may be perforated by a processing machine after thermal compression bonding and before baking during the above-mentioned step.

Then, the frictional contact-sections 4 are bonded to predetermined positions of the piezoelectric elements by an epoxy adhesive.

Subsequently, the pin 5 serving as a projection and composed of the foregoing resin material is inserted into and bonded to the hole 2a perforated at the central part of the piezoelectric element. Although the hole 2a is perforated at the central part of the piezoelectric element and the pin 5 serving as a projection is inserted into and bonded to the hole 2a in this step, the pin 5 serving as a projection and composed of a resin material may be bonded to the central part of the piezoelectric element without providing the hole 2a at the central part of a piezoelectric element corresponding to the piezoelectric laminated-section 2.

In a manner as described above, the ultrasonic vibrator 1 is formed.

As a modification of the method for fabricating the ultrasonic vibrator 1 according to the present embodiment, for example, when a pressing die including a punch (a male die) having an external shape so as to form the frictional contact-sections 4 integrally with the piezoelectric laminated-section 2 and a die (a female die) for performing the above-mentioned cutting process, the piezoelectric laminated-section 2 having the two frictional contact-sections 4 disposed on the bottom surface thereof can be obtained.

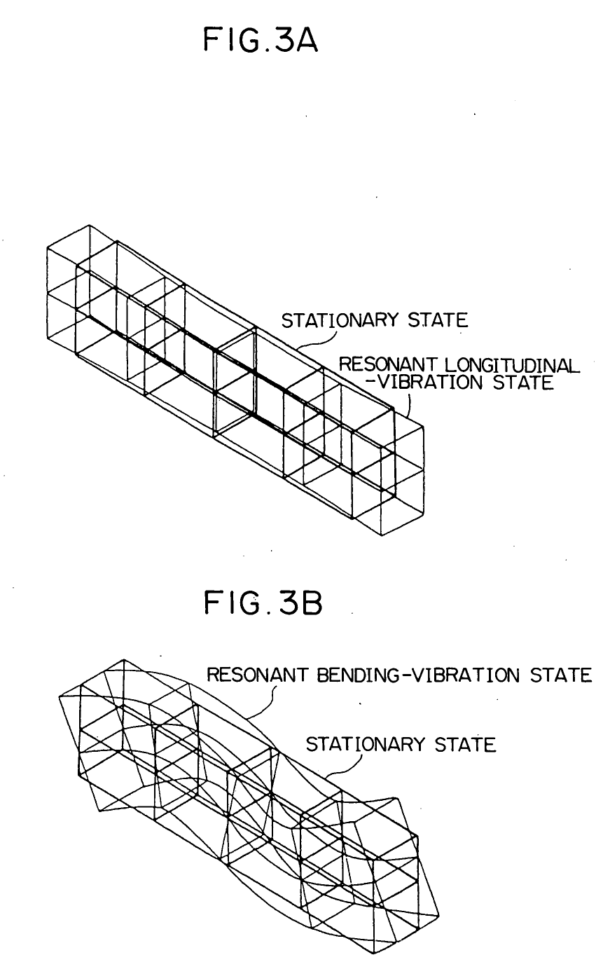

An operation of the above-described ultrasonic vibrator 1 will be described in detail with reference to FIG. 3.

Applying alternating voltages being in phase and having a predetermined frequency on the A- and B-phases of the ultrasonic vibrator 1 shown in FIG. 1 excites a primary longitudinal vibration in the ultrasonic vibrator 1, and applying alternating voltages being in opposite phase and having a predetermined frequency on the A- and B-phases excites a secondary bending vibration in the same.

A computer analysis of these vibrations with a finite element method shows that the ultrasonic vibrator 1 is expected to be respectively in states of a resonant longitudinal vibration and a resonant bending vibration as shown in FIG. 3A and 3B, respectively. Measured results of ultrasonic vibrations prove this expectation to be true. Meanwhile, the frictional contact-sections 4 are omitted in FIGS. 3A and 3B.

According to the present embodiment, the ultrasonic vibrator 1 is designed such that a secondary bending vibration has a lower resonant frequency than that of a primary longitudinal vibration by about several percent (preferably by about three percent). With this structure, an output feature of an ultrasonic motor is drastically improved, which will be described later.

When alternating voltages being mutually π/2 out of phase and having a predetermined frequency are applied on the A- and B-phases of the ultrasonic vibrator 1, an elliptic vibration is observed at each of the frictional contact-sections 4 of the ultrasonic vibrator 1.

Referring now to FIGS. 4 and 5, the structure of an ultrasonic motor 10 including the ultrasonic vibrator 1 will be described. FIG. 4 is sectional view of the internal structure of the ultrasonic motor and FIG. 5 is a side view of a major part of the ultrasonic motor shown in FIG. 4.

As shown in FIGS. 4 and 5, the ultrasonic motor 10 according to the present embodiment includes the ultrasonic vibrator 1 having the above-mentioned structure; a moving-table 11 serving as a driven body; a base table 12 including the projection-holding member 15 holding the ultrasonic vibrator 1; linear guides 13 connecting the moving-table 11 and the base table 12 to each other so as to be linearly movable; a sliding member 14 disposed inside the moving-table 11, against which the frictional contact-sections 4 of the ultrasonic vibrator 1 are abutted; and a leaf spring 16 serving as pressing means, for urging the projection-holding member 15 so as to press the ultrasonic vibrator 1 and the projection-holding member 15, both disposed on and accommodated in the base table 12, against each other at a predetermined pressing force.

The moving-table 11 is formed in a C-shape and has side surface sections 11A having the respective linear guide 13 disposed at the top thereof. The base table 12 has a pair of guide sections 12A disposed therein in a standing manner so as to face the other halves of corresponding linear guides 13.

The linear guides 13 have bearings 13a disposed therein and connect the moving-table 11 and the base table 12 so as to be mutually movable. Although the moving-table 11 is regulated so as to move linearly in the present embodiment by way of example, when the linear guides. 13 are formed so as to have a gentle curve extending in the vertical or horizontal direction or in both vertical and horizontal directions, the moving-table 11 can be driven along the curve.

The sliding member 14 is composed of, for example, zirconia ceramics and bonded to the lower surface of the moving-table 11. The frictional contact-sections 4 of the ultrasonic vibrator 1 held by the projection-holding member 15 are abutted against the sliding member 14.

In this case, the frictional contact-sections 4 are urged against the sliding member 14 at a predetermined pressing force by the leaf spring 16.

An abutment portion of the sliding member 14 having the frictional contact-sections 4 abutted thereagainst is composed of zirconia ceramics having a surface roughness Ra (defined as an arithmetic mean roughness stipulated in Japanese Industrial Standards (JIS) B0601) not greater than 0.05 μm.

The ultrasonic vibrator 1 is held by the projection-holding member 15. More particularly, as shown in FIGS. 4 and 5, the projection-holding member 15 has a V-shaped groove 5a formed at the upper part thereof, and the pin 5 serving as a projection of the ultrasonic vibrator 1 is engaged with and held by the V-shape groove 5a.

The projection-holding member 15 and the ultrasonic vibrator 1 have spacers 16A interposed therebetween so as to pass through the pin 5 disposed on the ultrasonic vibrator 1.

While the projection-holding member 15 is composed of a highly functional resin such as polyether-ether-ketone (a PEEK material: PEER R-polymer) in the present embodiment, other than the above-mentioned resin material, it may be composed of a resin material such as nylon, polyethylene, polyacetal, ABS resin, polycarbonate, polysulfone, polyimide, polystyrene, polyphenylene sulfide, polypropylene, phenol resin, epoxy resin, or FRP resin.

As shown in FIG. 5, the projection-holding member 15 has the central part of the leaf spring 16 fixed to the bottom surface thereof. Both side ends of the leaf spring 16 are fixed to predetermined positions of the base table 12 by corresponding screws 17.

An urging force of the leaf spring 16 presses the ultrasonic vibrator 1 against the surface of the sliding member 14 of the moving-table 11 serving as a driven body through the projection-holding member 15.

An operation of the ultrasonic motor 10 will be described.

When alternating voltages being mutually π/2 out of phase and having a predetermined frequency are applied on the respective electrical terminals (A+ and A−) and (B+ and B−) of the A- and B-phases, a primary longitudinal vibration and a secondary bending vibration are excited, thereby producing a clockwise or counterclockwise ultrasonic elliptical vibration at each of the frictional contact-sections 4.

As described above, in the present embodiment, generating an ultrasonic elliptical vibration at each of the frictional contact-sections 4 of the ultrasonic vibrator 1 allows the moving-table 11 to be driven horizontally (in arrow A direction indicated in FIG. 5). That is, since the ultrasonic vibrator 1 is fixed to the base table 12 though the pin 5 and the projection-holding member 15, the moving-table 11 moves horizontally free from noise generation.

With this structure, according to the present embodiment, because of being composed of a highly functional resin such as polyether-ether-ketone (a PEEK material: PEER R-polymer), the pin 5 serving as a projection and the projection-holding member 15 damp and absorb a vibration generated by the ultrasonic vibrator 1 with a large vibration-damping property inherent to a resin material. Hence, no vibration leaks towards the ultrasonic motor 10, thereby allowing the motor 10 to be driven nearly free from noise.

In addition, since the ultrasonic motor 10 is achieved with a simple structure, its cost and size are reduced.

While the pin 5 serving as a projection and the projection-holding member 15 are both composed of a resin material such as polyether-ether-ketone (a PEEK material: PEER R-polymer) in the present embodiment, these components are not limited to such an arrangement. For example, it is sufficient that either the pin 5 or the projection-holding member 15 is composed of a resin material.

More particularly, when the pin 5 is composed of a metal material (i.e., other than a resin material) such as a stainless steel, the projection-holding member 15 is composed of a resin material. On the contrary, when the pin 5 is composed of a resin material, the projection-holding member 15 is composed of a metal material (i.e., other than a resin material) such as a stainless steel.

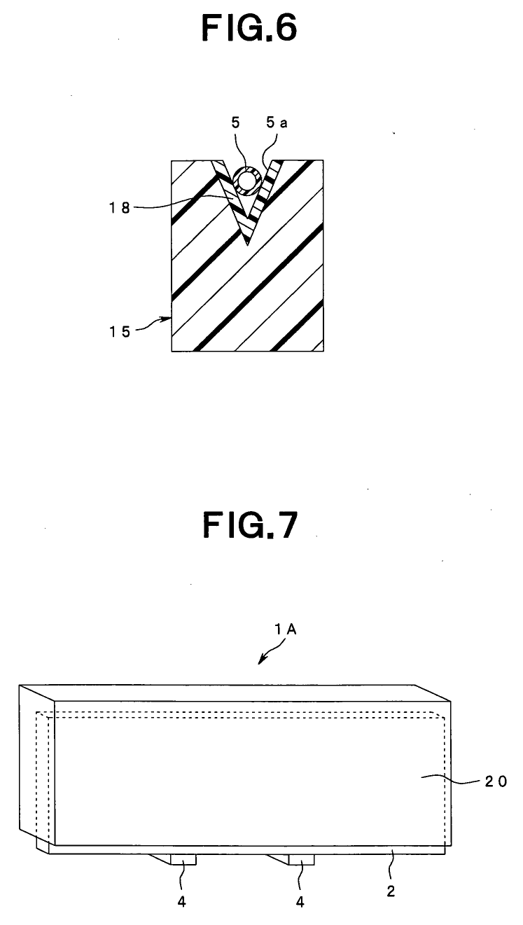

As shown in FIG. 6 as a modification of the present embodiment, the projection-holding member 15 may have a damping member 18, having the same cross-sectional shape as that of the V-shaped groove 5a and composed of an absorbing material, for example, a damping material such as a dumping rubber, bonded to the V-shaped groove 5a having the pin 5 engaged therewith. Thus, the damping member 18 disposed as described above is engaged with the pin 5, thereby further effectively absorbing a vibration and accordingly contributing to noise prevention to a large extent. Although not shown, a damping member composed of silicone or the like may be disposed around the pin 5.

Concerning the structures of the internal electrodes, instead of dividing a negative electrode into two terminals (A− and B−), it may be formed as an overall electrode in the present embodiment. In this case, the terminals (A− and B−) serve as a common negative electrode.

While a piezoelectric element is of a laminated-type in the present embodiment, even with that of a plate type, an ultrasonic vibrator having the same structure as described above can be fabricated.

While an example ultrasonic motor has a structure in which the ultrasonic vibrator 1 is fixed and the driven body (the moving-table 11) is linearly moved in the present embodiment, an ultrasonic motor may include the ultrasonic vibrator 1 of a self-driven type.

While the leaf spring 16 is used for generating a pressing force in the present embodiment, a usual coil spring may be used.

### Second Embodiment

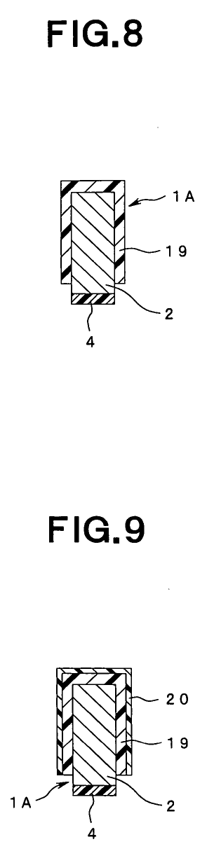

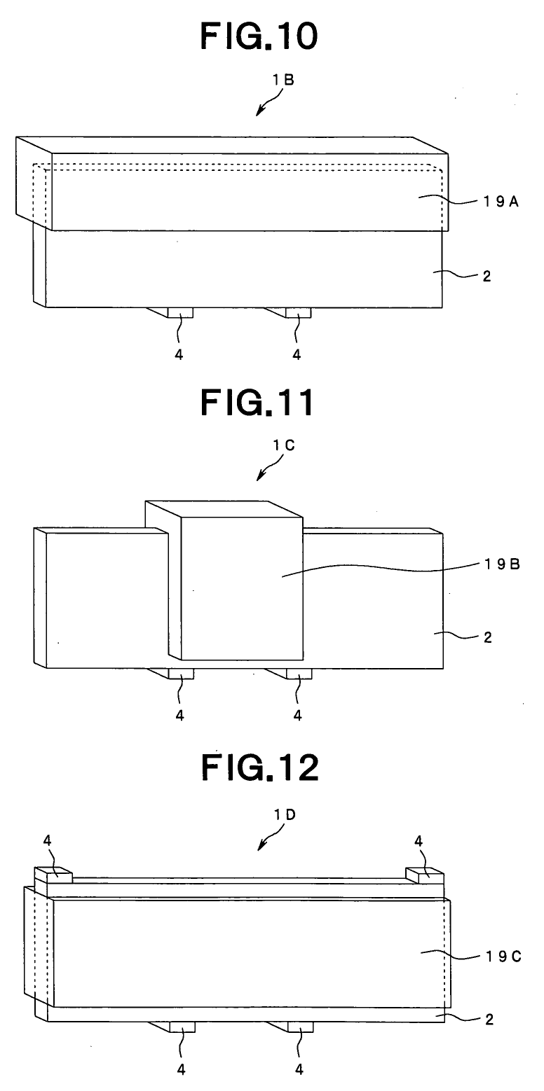

FIGS. 7 to 9 illustrate the structure of an ultrasonic vibrator according to a second embodiment of the present invention, wherein FIG. 7 is a perspective view of the structure of the ultrasonic vibrator, FIG. 8 is a sectional view of the ultrasonic vibrator shown in FIG. 7, and FIG. 9 is a sectional view of the ultrasonic vibrator shown in FIG. 7, having a holding-casing disposed thereon. FIGS. 10 to 12 are respectively perspective views of first to third modifications of the ultrasonic vibrator according to the second embodiment. While the same parts shown in FIGS. 7 to 9 as those of the ultrasonic vibrator 1 according to the first embodiment are denoted by the same reference numbers and their descriptions are omitted, only different parts from those of the ultrasonic vibrator 1 will be described.

As shown in FIG. 7, an ultrasonic vibrator 1A according to the present embodiment includes the piezoelectric laminated-section 2 having the same structure as that of the ultrasonic vibrator 1 according to the first embodiment and is held by a holding member 19 and a holding-casing 20 having the holding member 19 accommodated therein, both composed of a resin member and formed so as to cover the piezoelectric laminated-section 2, instead of being held by the pin 5 serving as a projection.

More particularly, as shown in FIG. 9, the ultrasonic vibrator 1A according to the present embodiment includes the same piezoelectric laminated-section 2 as that in the first embodiment; the holding member 19 covering the piezoelectric laminated-section 2; and the holding-casing 20 having the holding member 19 accommodated therein.

As shown in FIGS. 7 and 8, the holding member 19 is composed of a resin material such as silicone rubber so as to cover the overall periphery of the main body of the piezoelectric laminated-section 2 other than its bottom part. In this case, the silicone rubber making up the holding member 19 has an example thickness in a range from 0.5 to 3 mm.

As shown in FIG. 9, the ultrasonic vibrator 1A has the holding-casing 20 disposed therein so as to surround the holding member 19. The holding-casing 20 may be composed of a resin material as shown in the figure or a stainless steel alternatively.

As described above, the ultrasonic vibrator 1A according to the present embodiment is covered by the holding member 19 composed of silicone rubber, and further, the holding member 19 is covered by the holding-casing 20. While the holding-casing 20 is provided in the present embodiment, the ultrasonic vibrator 1A is not limited to this structure. As shown in FIG. 8, it may have only the holding member 19 disposed therein.

With an excellent resilient property, silicone rubber making up the holding member 19 is suitable for holding the ultrasonic vibrator 1A free from damping a vibration generated by the ultrasonic vibrator 1A.

Due to difference in their mechanical impedances, a vibration generated by the ultrasonic vibrator 1A is insulated by the silicone rubber, and a property of preventing leakage of vibration is hence provided. Further, with the holding-casing 20 being provided, an effect of prohibiting leakage of vibration is improved.

Other than silicone rubber, as a candidate material for making the holding member 19 in the present embodiment, urethane rubber, ethylene-propylene rubber, nitrile rubber, butyl-rubber, chloroprene rubber, butadiene rubber, styrene rubber, natural rubber, and the like are listed. The holding member 19 may be composed of any one of these kinds of material.

A method for fabricating the ultrasonic vibrator 1A according to the present embodiment will be described.

The silicone rubber used in the present embodiment is curable resin composed of a base agent and a curing agent as is well known.

The piezoelectric laminated-section 2 is first set in a mold (not shown), and the silicone rubber prepared by mixing the base agent and the curing agent with each other is poured into the gap between the piezoelectric laminated-section 2 and the mold having the piezoelectric laminated-section 2 accommodated therein. When the silicone rubber is cured by the curing agent, the mold is separated from the cured silicone rubber. With this arrangement, the ultrasonic vibrator 1A is formed as shown in FIGS. 7 and 8. In the present embodiment, the ultrasonic vibrator 1A has no silicone rubber disposed on its surface having the frictional contact-sections 4 disposed thereon.

In the present embodiment, the ultrasonic vibrator 1A is not limited to an example structure as shown in FIG. 9. Instead, as the first modification of the ultrasonic vibrator 1A, as shown in FIG. 10, an ultrasonic vibrator 1B may have another example structure in which substantially the upper half of the piezoelectric laminated-section 2 is covered by a holding member 19A composed of silicone rubber.

Alternatively, as the second modification of the ultrasonic vibrator 1A, as shown in FIG. 11, an ultrasonic vibrator 1C may have a structure in which substantially the central part of the piezoelectric laminated-section 2 is covered by a holding member 19B composed of silicone rubber and formed in a C-shape.

Further alternatively, as the third modification of the ultrasonic vibrator 1A, as shown in FIG. 12, an ultrasonic vibrator 1D may have an example structure in which the periphery of the piezoelectric laminated-section 2, other than the upper and lower parts thereof, is covered by a holding member 19C composed of silicone rubber and formed in a belt shape. In this case, the ultrasonic vibrator 1D is capable of having the additional frictional contact-sections 4 disposed at both ends of the upper part of the piezoelectric laminated-section 2. As a result, generating elliptical vibrations at the upper and lower frictional contact-sections 4 allow the ultrasonic vibrator 1D itself to be driven horizontally, thereby achieving a self-driven ultrasonic motor.

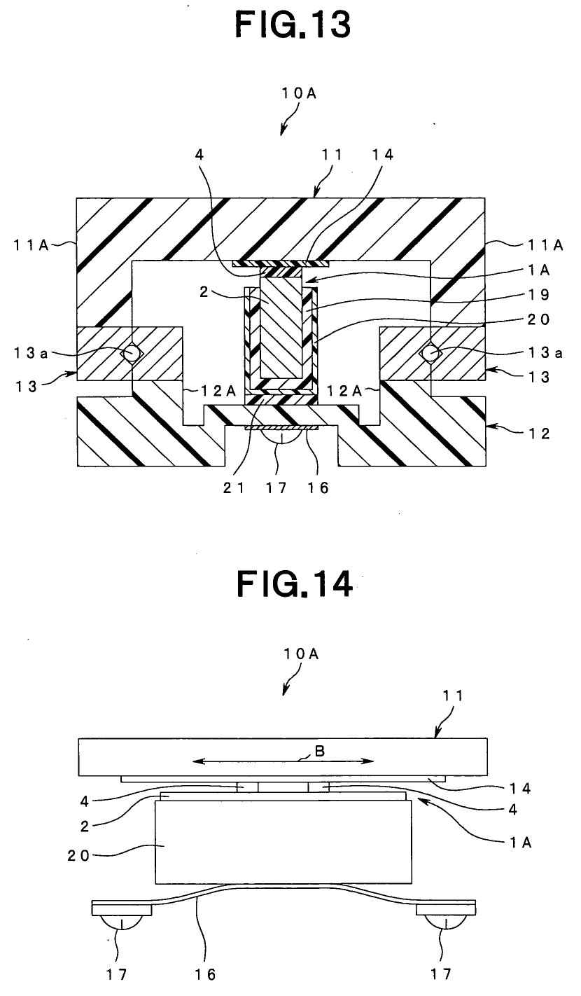

Referring now to FIGS. 13 and 14, the structure of an ultrasonic motor 10A including the ultrasonic vibrator 1A will be described.

FIGS. 13 and 14 illustrate the structure of the ultrasonic motor 10A including the ultrasonic vibrator 1A, wherein FIG. 13 is a sectional view of the internal structure of the ultrasonic motor 10A, and FIG. 14 is a side view of a major part of the ultrasonic motor 10A shown in FIG. 13. While the same parts shown in FIGS. 13 and 14 as those of the ultrasonic motor 10 according to the first embodiment are denoted by the same reference numbers and their descriptions are omitted, only different parts from those of the ultrasonic motor 10 will be described.

As shown in FIGS. 13 and 14, the ultrasonic motor 10A includes the ultrasonic vibrator 1A shown in FIG. 9.

The holding-casing 20 of the ultrasonic vibrator 1A has the central part of the leaf spring 16 fixed on the bottom surface thereof through a fixing section 21. In the same fashion as in the first embodiment, the both side ends of the leaf spring 16 are fixed to predetermined positions of the base table 12 by the corresponding screws 17.

An urging force of the leaf spring 16 presses the ultrasonic vibrator 1A against the surface of the sliding member 14 of the moving-table 11 serving as a driven body through the fixing section 21 and the holding-casing 20.

The other structure of the ultrasonic motor 10A is the same as that of the ultrasonic motor 10 according to the first embodiment.

When the ultrasonic motor 10A includes one of the ultrasonic vibrators 1A (and 1B, 1C, and 1D) having no holding-casing 20 disposed therein, the corresponding one of holding members 19 (and 19A, 19B, and 19C) is connected and fixed to the driven body (the moving-table 11) through the leaf spring 16.

An operation of the ultrasonic motor 10A will be described.

When alternating voltages being mutually π/2 out of phase and having a predetermined frequency are respectively applied on the electrical terminals (A+ and A−) and (B+ and B−) of the A- and B-phases, a primary longitudinal vibration and a secondary bending vibration are excited, thereby producing a clockwise or counterclockwise ultrasonic elliptical vibration at each of the frictional contact-sections 4.

As described above, generation of an ultrasonic elliptical vibration at each of the frictional contact-sections 4 of the ultrasonic vibrator 1A allows the moving-table 11 to be horizontally driven (in arrow B direction indicated in FIG. 14). In other words, the ultrasonic vibrator 1A is fixed to the base table 12 though the holding member 19, the holding-casing 20, and the fixing section 21, whereby the moving-table 11 moves horizontally free from noise generation.

According to the present embodiment, since the ultrasonic vibrator 1A includes the holding member 19 and the holding-casing 20 composed of silicone rubber and formed so as to cover the piezoelectric laminated-section 2, the ultrasonic motor 10A has the ultrasonic vibrator 1 held therein without inhibiting a vibration generated by the ultrasonic vibrator 1A. Also, due to difference in mechanical impedances between the silicone rubber and the ultrasonic vibrator 1A, vibration generated by the ultrasonic vibrator 1A is hardly leaked outside the ultrasonic vibrator 1A. Also, the holding-casing 20 having the holding member 19 accommodated therein and damping a vibration is provided, so no vibration is transferred to the internal mechanism of the ultrasonic motor 10A, thereby achieving the ultrasonic motor 10A free from noise. Other advantages are the same as those obtained in the first embodiment.

A variety of modifications of the present invention obviously fall in the scope of the present invention without departing from the spirit of the present invention. The present invention is limited only by the attached claims and not limited by its particular embodiments.

1. An ultrasonic vibrator comprising:
a piezoelectric section;
a frictional contact-section serving as a driving point upon coming into contact with a driven body and generating an ultrasonic elliptical vibration upon application of alternating voltages on the piezoelectric section; and
a projection disposed at a node of a vibration generated in the piezoelectric section and comprising a resin member.

2. The ultrasonic vibrator according to claim 1, wherein an ultrasonic elliptical vibration generated at the frictional contact-section is produced by synthesizing a primary-mode longitudinal vibration and a secondary-mode bending vibration.

3. The ultrasonic vibrator according to claim 1, wherein the resin member comprises polyether-ether-ketone.

4. An ultrasonic vibrator comprising:
a piezoelectric section;
a frictional contact-section serving as a driving point upon coming into contact with a driven body and generating an ultrasonic elliptical vibration upon application of alternating voltages on the piezoelectric section;
a projection disposed at a node of a vibration generated in the piezoelectric section and
a resin member disposed around the projection.

5. The ultrasonic vibrator according to claim 4, wherein an ultrasonic elliptical vibration generated at the frictional contact-section is produced by synthesizing a primary-mode longitudinal vibration and a secondary-mode bending vibration.

6. The ultrasonic vibrator according to claim 4, wherein the resin member comprises polyether-ether-ketone.

7. An ultrasonic motor, comprising:
an ultrasonic vibrator including a piezoelectric section, a frictional contact-section serving as a driving point upon coming into contact with a driven body and generating an ultrasonic elliptical vibration upon application of alternating voltages on the piezoelectric section, and a projection disposed at a node of a vibration generated in the piezoelectric section;
a projection-holding member holding the ultrasonic vibrator upon engagement with the projection;
the driven body; and
a pressing member generating a pressing force between the frictional contact-section and the driven body through the projection-holding member,
wherein the driven body moves relative to the frictional contact-section of the ultrasonic vibrator upon coming into contact with the frictional contact-section, and
wherein at least either one of the projection and the projection-holding member comprises a resin member.

8. The ultrasonic motor according to claim 7, wherein an ultrasonic elliptical vibration generated at the frictional contact-section is produced by synthesizing a primary-mode longitudinal vibration and a secondary-mode bending vibration.

9. The ultrasonic motor according to claim 7, wherein the resin member comprises polyether-ether-ketone.

10. An ultrasonic motor comprising:
an ultrasonic vibrator including a piezoelectric section, a frictional contact-section serving as a driving point upon coming into contact with a driven body and generating an ultrasonic elliptical vibration upon application of alternating voltages on the piezoelectric section, and a projection disposed at a node of a vibration generated in the piezoelectric section;
a projection-holding member holding the ultrasonic vibrator upon engagement with the projection;
the driven body;
a pressing member generating a pressing force between the frictional contact-section and the driven body through the projection-holding member; and
a resin member disposed on at least either one of the projection and the projection-holding member,
wherein the driven body moves relative to the frictional contact-section of the ultrasonic vibrator upon coming into contact with the frictional contact-section, and
wherein the projection and the projection-holding member have the resin member interposed therebetween.

11. The ultrasonic motor according to claim 10, wherein an ultrasonic elliptical vibration generated at the frictional contact-section is produced by synthesizing a primary-mode longitudinal vibration and a secondary-mode bending vibration.

12. The ultrasonic motor according to claim 10, wherein the resin member comprises polyether-ether-ketone.

13. An ultrasonic vibrator comprising:
a piezoelectric section;
a frictional contact-section serving as a driving point upon coming into contact with a driven body and generating an ultrasonic elliptical vibration upon application of alternating voltages on the piezoelectric section; and
a holding-member holding the piezoelectric section.

14. The ultrasonic vibrator according to claim 13, wherein an ultrasonic elliptical vibration generated at the frictional contact-section is produced by synthesizing a primary-mode longitudinal vibration and a secondary-mode bending vibration.

15. The ultrasonic vibrator according to claim 13, wherein the holding-member comprises a resin member.

16. The ultrasonic vibrator according to claim 15, wherein the resin member comprises silicone rubber.

17. An ultrasonic vibrator comprising:
a piezoelectric section;
a frictional contact-section serving as a driving point upon coming into contact with a driven body and generating an ultrasonic elliptical vibration upon application of alternating voltages on the piezoelectric section;
a holding-member holding the piezoelectric section; and
a holding-casing covering the holding member.

18. The ultrasonic vibrator according to claim 17, wherein an ultrasonic elliptical vibration generated at the frictional contact-section is produced by synthesizing a primary-mode longitudinal vibration and a secondary-mode bending vibration.

19. The ultrasonic vibrator according to claim 17, wherein the holding member comprises a resin member.

20. The ultrasonic vibrator according to claim 19, wherein the resin member comprises silicone rubber.

21. An ultrasonic motor comprising:
an ultrasonic vibrator including a piezoelectric section, a frictional contact-section serving as a driving point upon coming into contact with a driven body and generating an ultrasonic elliptical vibration upon application of alternating voltages on the piezoelectric section, and a holding member holding the piezoelectric section;
a holding-casing in which the holding member of the ultrasonic vibrator is inserted;
the driven body; and
a pressing member generating a pressing force between the frictional contact-section and the driven body through the holding-casing,
wherein the driven body moves relative to the frictional contact-section of the ultrasonic vibrator upon coming into contact with the frictional contact-section.

22. An ultrasonic motor comprising:
an ultrasonic vibrator including a piezoelectric section, a frictional contact-section serving as a driving point upon coming into contact with a driven body and generating an ultrasonic elliptical vibration upon application of alternating voltages on the piezoelectric section, and a holding member holding the piezoelectric section, and a holding-casing in which the holding member of the ultrasonic vibrator is inserted;
the driven body; and
a pressing member generating a pressing force between the frictional contact-section and the driven body through the holding-casing,
wherein the driven body moves relative to the frictional contact-section of the ultrasonic vibrator upon coming into contact with the frictional contact-section.
